(19) United States
(12) Patent Application Publication
(10) Pub. No.: US 2014/0263794 A1
(43) Pub. Date: Sep. 18, 2014

(54) FISHING LINE SPOOL

(71) Applicant: John M. BRUNO, Walpole, MA (US)

(72) Inventor: John M. BRUNO, Walpole, MA (US)

(21) Appl. No.: 14/205,643

(22) Filed: Mar. 12, 2014

Related U.S. Application Data
(60) Provisional application No. 61/781,151, filed on Mar. 14, 2013.

(51) Int. Cl. A01K 89/00

(52) U.S. Cl. CPC A01K 89/003
USPC 242/323

(57) ABSTRACT

A method of removing previously used fishing line from a fishing reel includes mounting a fishing line spool in a rotation apparatus, the fishing line spool including rods and a face plate including elliptical slots, each rod slidably secured via a rod securing mechanism to an elliptical slot at a slot end closest to a circumferential edge of the face plate, rotating the mounted fishing line spool to remove the previously used fishing line from the fishing reel and winding the fishing line around the rods, adjusting a rod securing mechanism, sliding at least one rod along the slot towards a center of the face plate such that the sliding reduces tension on the fishing line, removing the fishing line from the fishing line spool, securing the rod to the slot at the slot end portion closest to the edge of the face plate, and reusing the fishing line spool.

### CROSS REFERENCE TO RELATED APPLICATIONS

This application claims the benefit of U.S. Provisional Application No. 61/781,151, filed Mar. 14, 2013 and entitled “Fishing Line Winder.”

### BACKGROUND

Fishing line is removed from a fishing reel in order, for example, to clean the fishing reel or to replace the fishing line. The fishing line may be replaced in order to reline the fishing reel with undamaged fishing line or fishing line of a different weight.

Fishing line removal and replacement equipment provided by a tackle shop is typically heavy, stationary equipment. Portable fishing line removal equipment typically removes fishing line in a manner consistent with disposal of the removed line. Portable fishing line replacement equipment is typically configured to reline a fishing reel with new (i.e., previously unused) fishing line.

### SUMMARY

An example of a method of removing previously used fishing line from a fishing reel includes mounting a fishing line spool in a rotation apparatus, the fishing line spool including four rods and a face plate including four elliptical slots, each rod slidably secured via a rod securing mechanism to a corresponding elliptical slot at a slot end portion closest to a circumferential edge of the face plate, rotating the mounted fishing line spool such that the rotating removes the previously used fishing line from the fishing reel and winds the previously used fishing line around the four rods, adjusting at least one rod securing mechanism, sliding at least one rod along the corresponding elliptical slot towards a center of the face plate such that the sliding reduces tension on the previously used fishing line, removing the previously used fishing line from the fishing line spool, securing the at least one rod to the corresponding elliptical slot at the slot end portion closest to the circumferential edge of the face plate, and reusing the fishing line spool.

An example of a fishing line spool includes a first face plate, substantially in a disc shape, with an interior surface, an exterior surface, and a circumferential edge, the first face plate including a central bore in the first face plate, the central bore being disposed in an approximate center of the first face plate and extending through the first face plate from the exterior surface to the interior surface and slots extending through the first face plate from the exterior surface to the interior surface and in an area between the central bore and the circumferential edge of the first face plate, each of the slots being disposed at a regular angular interval around the central bore and at a radial distance from the central bore, a central spindle secured to the first face plate and extending from the central bore, and rods, each rod extending from a corresponding slot and a first end portion of each rod being slidably secured to the corresponding slot.

Implementations of such a fishing line spool may include one or more of the following features. Each slot may have a slot length along a radial direction, the slot length being greater than a slot width along an angular direction. Each of the rods may be slidably secured to a slot end portion closest to the circumferential edge of the first face plate. A second end portion of each rod may include an end cap, an outer diameter of the end cap being greater than a rod diameter of a corresponding rod. The first face plate, the rods, and the central spindle may be substantially composed of one or more corrosion resistant materials. At least a first end portion of the central spindle may have a cross-sectional shape compatible with a chuck of a drill. The fishing line spool may include a second face plate substantially the same as the first face plate, the second face plate being parallel to the first face plate and separated from the first face plate by a distance between the first face plate and the second face plate and an interior surface of the second face plate facing the interior surface of the first face plate. The central spindle may span the distance between the first face plate and the second face plate and insert through a central bore in the second face plate, the central spindle being secured to the second face plate. The rods may span the distance between the first face plate and the second face plate and each of the rods may insert into a slot in the second face plate. The central spindle may be rotatably secured to a fishing line spooling apparatus.

An example of a fishing line spooling apparatus may include a horizontal base plate with a first edge and a second edge opposite the first edge, a first spindle support plate extending up from the horizontal base plate and including a U-shaped cut-out extending from a top edge of the first spindle support plate into a top portion of the first spindle support plate, the first spindle support plate being secured to the first edge of the horizontal base plate at a bottom portion of the first spindle support plate, a second spindle support plate substantially the same as the first spindle support plate, the second spindle support plate being secured to the second edge of the horizontal base plate along a bottom portion of the second spindle support plate, one or more fishing rod clamps secured to the horizontal base plate, and a fishing line spool including slidable rods and a central spindle, the central spindle being disposed in the U-shaped cut-out of the first spindle support plate and the U-shaped cut-out of the second spindle support plate.

Implementations of such a fishing line spooling apparatus may include one or more of the following features. The fishing line spool may include a length of previously used fishing line. The fishing line spooling apparatus may further include a collar, disposed on an exterior surface of the first spindle support plate, that encircles a first end portion of the central spindle and a set screw that extends into the collar and is configured to contact the first end portion and a spring-loaded screw that inserts into a second end portion of the central spindle, the second end portion of the central spindle being hollow and an interior surface of the second end portion being threaded. At least one supported portion of the central spindle may include a bushing. The fishing line spooling apparatus may include at least one of a first spindle clamp secured to the top edge of the first spindle support plate or a second spindle clamp secured to the top edge of the second spindle support plate. The first spindle clamp may extend across the U-shaped cut-out in the first spindle support plate along the top edge of the first spindle support plate and a first spindle clamp screw may extend into the U-shaped cut-out in the first spindle support plate, the first spindle clamp screw being configured to contact the central spindle and the second spindle clamp may extend across the U-shaped cut-out in the second spindle support plate along the top edge of the first spindle support plate and a second spindle clamp screw may extend into the U-shaped cut-out in the second spindle support plate, the second spindle clamp screw being configured to contact the central spindle. The first spindle support plate may be secured to the horizontal base plate via a first hinge and the second spindle support plate may be secured to the horizontal base plate via a second hinge such that, in a closed position of the first hinge and the second hinge, the first spindle support plate and the second spindle support plate overlap the horizontal base plate. The horizontal base plate may include one or more fishing rod clamps secured to fishing rod clamp tracks, the fishing rod clamp tracks being configured to enable adjustment of a position of the one or more fishing rod clamps. The fishing line spooling apparatus may include a spool handle secured to a first end portion of the central spindle. The spool handle may include a drag washer assembly, a line counting mechanism, and a drag scale removably secured to the horizontal base plate. The horizontal base plate may include at least two base plate portions connected by an adjustable connection mechanism.

Items and/or techniques described herein may provide one or more of the following capabilities, as well as other capabilities not mentioned.

A fishing line spooling apparatus can both remove used fishing line from a fishing reel and reline the fishing reel with previously used fishing line. Furthermore, the fishing line spooling apparatus is compatible with a fishing line spool that includes slidable rods. The fishing line spool and/or the slidable rods can facilitate storage of the used fishing line, transfer of the used fishing line to another fishing line spool, reuse of the used fishing line, disposal of the used fishing line and/or reuse of the fishing line spool. The fishing line spool is further compatible with a hand-held drill for use in removing fishing line from the fishing reel or relining the fishing reel. The portability of the fishing line spooling apparatus and the fishing line spool along with the reuse of the fishing line and fishing line spool may decrease costs and increase convenience for a fishing hobbyist.

Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTIONS OF THE DRAWINGS

In the appended figures, similar components and/or features may have the same reference label.

FIG. 1A is a cross-sectional schematic diagram of a fishing line spool with a first face plate.

FIG. 1B is a schematic diagram of an exterior face of the first face plate of the fishing line spool.

FIG. 2 is a schematic diagram of the fishing line spool mounted in a hand-held electric drill.

FIG. 3A is a cross-sectional schematic diagram of a fishing line spool including the first face plate and a second face plate.

FIG. 3B is a schematic diagram of an exterior face of the second face plate of the fishing line spool.

FIGS. 4A, 4B, 4C, 4D, and 4E are schematic diagrams of a top view, an unassembled end view, an assembled end view, and side views of a fishing line spooling apparatus.

FIG. 5 is a schematic diagram of horizontal base plate cross-section examples.

FIG. 6A is a schematic diagram of a top view of the fishing line spooling apparatus.

FIG. 6B is a schematic diagram of a side view of the fishing line spooling apparatus.

FIG. 7A is a schematic diagram of hinged spindle support plates.

FIGS. 7B and 7C are schematic diagrams of a hinged horizontal base plate with storage compartments.

FIG. 8 is a schematic diagram of a method of removing fishing line from a fishing reel.

FIG. 9 is a schematic diagram of a method of relining a fishing reel.

### DETAILED DESCRIPTION

Apparatuses and methods are discussed herein for removing fishing line from a reel and relining a fishing reel. The apparatuses and methods discussed below are examples, however, and not limiting of the invention as other implementations in accordance with the disclosure are possible. For example, a fishing line spool includes slidable rods inserted in corresponding slots. The slidable rods slide towards a center of the fishing line spool to reduce tension on a length of fishing line wound around the fishing line spool. The fishing line may be removed from the fishing line spool or transferred to another fishing line spool. The fishing line spool may be mounted in a fishing line spooling apparatus along with a fishing reel. Previously used fishing line may be removed from the fishing reel and wound around the fishing line spool. Further, previously used fishing line wound around the fishing line spool may be removed from the fishing line spool and wound around the fishing reel to reline the fishing reel.

Referring to FIGS. 1A and 1B, an example of a fishing line spool 5 includes a face plate 10, a central spindle 40, rods 50, end caps 56, a spindle securing mechanism 80, and rod securing mechanism 82. The cross-section of FIG. 1A is taken at line 98 of the end view in FIG. 1B. The shape and configuration of the fishing line spool 5, as shown in FIGS. 1A and 1B, and the shapes, configurations, and quantities of components thereof, as shown in FIGS. 1A and 1B, are only examples and not limiting of the invention as other shapes, configurations, and quantities in accordance with the disclosure are possible. The fishing line spool 5 may be altered, e.g., by having components added, removed, reshaped, or rearranged. At least any or all of the face plate 10, the central spindle 40, the rods 50, the end caps 56, the spindle securing mechanism 80, and/or the rod securing mechanism 82 may be substantially composed of one or more corrosion resistant materials (e.g., a corrosion resistant metal alloy such as an aluminum alloy or stainless steel alloy, a rigid thermoplastic polymer such as polycarbonate (PC), rigid polyvinylchloride (PVC), polyamide (nylon), polymethylmethacrylate (PMMA), acrylonitrile butadiene styrene (ABS), or other polymer blend, or any combination thereof).

The face plate 10 (e.g., a first face plate) can be substantially in a disc shape with an interior surface 12, an exterior surface 14, and a circumferential edge 18. The interior surface 12 and the exterior surface 14 have a shape for which a normal central axis 97 is a rotational axis of symmetry. For example, the shape may be substantially circular (e.g., as shown in FIG. 1B), square, triangular, clover-leafed, etc. In an example, the first face plate 10 may have a thickness of 3-19 mm and a diameter of 5-25 cm. Other thickness dimensions may also be used.

The first face plate 10 includes a central bore 16 and slots 30. The central bore 16 in the first face plate 10 is disposed in an approximate center of the first face plate 10 (i.e., substantially centered on the normal central axis 97) and extends through the first face plate 10 from the exterior surface 14 to the interior surface 12. The central bore 16 may include threads on an interior surface of the central bore 16. The slots 30 extend through the first face plate 10 from the exterior surface 14 to the interior surface 12. Four slots 30 are shown in FIG. 1B as an example only and not limiting of the invention. For example, the first face plate 10 may include two or more slots 30. The slots 30 are disposed in an area between the central bore 16 and the circumferential edge 18 and at a radial distance, R, from the normal central axis 97. For example, as shown schematically in FIG. 1B, R may be a distance to a slot end closest to the central bore 16. As a further example, R may be a distance to a center of each slot 30 or slot end closest to the circumferential edge 18. The length of R is greater than the diameter of the central bore 16 and less than the distance from the normal central axis 97 to the circumferential edge 18 (e.g., R is less than the radius of the first face plate 10 for a substantially circular first face plate 10). The slots 30 may be positioned at a regular angular interval, θ, around the central bore 16. The slot shape may be, for example, rectangular, elliptical, race-track, stair steps (e.g., with each step for each slot 30 being an equal distance from the central bore 16), etc. Each slot 30 has a slot length, SL, along a radial direction and a slot width, SW, along an angular direction, with SL being greater than SW. For example, SW may be 6-16 mm and SL may be 1.5-7.6 cm. Other slot dimensions may also be used. SL and/or SW may be equal for all of the slots 30 or may vary from slot to slot. The slots 30 may include one or more radius lines indicating an equal distance from the central bore 16 to a position on each of the slots 30.

The central spindle 40 extends from the central bore 16 along the normal central axis 97. The diameter of the central spindle 40 is less than the diameter of the central bore 16. For example, the central spindle 40 may have a length of 25-40 cm and a diameter of 3-13 mm. Other spindle dimensions may be used. An inner portion of the central spindle 40 may extend from the interior surface 12 and a first end portion 44 of the central spindle 40 may extend from the exterior surface 14. At least an end portion of the inner portion (e.g., a second end portion 46 of the central spindle 40) may be hollow with a threaded interior surface 48. The first end portion 44 may have, for example, a cross-sectional shape compatible with insertion of the central spindle 40 into a chuck of a drill, as discussed below with regard to FIG. 2. Additionally or alternatively, the first end portion 44 may include a threaded exterior surface configured to insert into a threaded opening in a spool handle, as discussed below with regard to FIGS. 6A and 6B.

The spindle securing mechanism 80 (e.g., a first spindle securing mechanism) secures the central spindle 40 to the first face plate 10. The first spindle securing mechanism 80 may be disposed on the exterior surface 14 and/or the interior surface 12 of the first face plate 10 and may be centered on the normal central axis 97. For example, the first spindle securing mechanism 80 may include a collar and set screw assembly, a compression fit rubber washer, a nut and washer assembly, etc. As other examples, an exterior surface of the central spindle 40 may be threaded to mate with threads of the central bore 16 to secure the central spindle 40 to the first face plate 10 or the central spindle 40 may be welded, glued, or otherwise bonded to the first face plate 10. The first face plate 10 and the central spindle 40 may be fabricated, for example, machined or molded, as a singular component.

A first portion of each rod 50 extends from a corresponding slot 30 with each rod 50 being a slidable rod 50. A second portion of each rod 50 inserts into the corresponding slot 30. Each rod 50 has a rod diameter, RD, RD being less than SW and less than SL. The rod diameter, RD, may be the same for the first portion and the second portion of each rod 50. Alternatively, the diameter of the first portion of each rod 50 may be greater than the diameter of the second portion of each rod 50. Each rod 50 may slide in a longitudinal direction perpendicular to the first face plate 10 and in a radial direction along the slot length. The rod securing mechanisms 82 slidably secure each corresponding rod 50 to the corresponding slot 30 at any position along the slot length. For example, each rod 50 may be slidably secured to the corresponding slot 30 at a slot end portion closest to the circumferential edge 18, as shown schematically in FIGS. 1A and 1B. Each rod securing mechanism 82 is disposed at a first end portion of each rod 50 proximal to the exterior surface 14 and includes an interior component 81. The interior component 81 is disposed at a position on each rod 50 proximal to the interior surface 12 of the first face plate 10. For example, the rod securing mechanism 82 and the interior component 81 may be nuts (e.g., a wing nut, quick release nut, a hexagonal nut, a compression fit rubber nut, etc.) and may include washers. Each rod 50 may include threads compatible with and configured to secure the rod securing mechanism 82 and the interior component 81. In an embodiment, for example, the interior component 81 may include a ring encircling the rod 50 or tabs extending radially from the rod 50. The interior component 81 and the rod 50 may be bonded together or may be machined and/or molded as a singular component. In a further example, if the diameter of the first portion of each rod 50 is greater than the diameter of the second portion of each rod 50, this change in rod diameter may provide a concentric ridge on the rod 50 proximal to the interior surface 12. The interior component 81 may include the concentric ridge formed by the change in rod diameter.

A second end portion of each rod 50 distal to the first face plate 10 may include an end cap 56. The end cap 56 can prevent fishing line from slipping off of the rod 50 because an outer diameter of the end cap, ECD, may exceed RD of the corresponding rod 50. The second end portion of each rod 50 may include a threaded outer surface and/or may be hollow with a threaded inner surface. The end cap 56 may be, for example, a threaded removable end cap secured to the threaded outer surface, a thumbscrew secured to the threaded inner surface, or a compression fit rubber end cap secured to the outer surface. As further examples, the end cap 56 may be bonded to the rod 50 or the end cap 56 and the rod 50 may be machined and/or molded as a singular component. The distance along each rod 50 between the interior surface 12 and the end cap 56, along each rod 50, is an inner rod portion length, IRPL. IRPL may be, for example, 5-30 cm. Other lengths may also be used. Four rods 50 are shown in FIG. 1B as an example only and not limiting of the invention. The number of rods 50 can be less than or equal the number of slots 30.

Referring to FIG. 2, with further reference to FIGS. 1A and 1B, an example of the fishing line spool 5 mounted in a drill 70 is shown schematically. At least the first end portion 44 of the central spindle 40 may have a cross-sectional shape and/or diameter compatible with insertion into a chuck 72 of the drill 70 (e.g., a hand-held drill, hand-held electric drill, etc.). For example, the cross-sectional shape and/or the diameter of the first end portion 44 of the central spindle 40 may enable the central spindle 40 to be secured in the drill 70 and rotated by the drill 70 about the normal central axis 97. The fishing line spool 5 may include a band 74 encircling and supported by the rods 50. The band 74 may be a flexible band substantially composed, for example, of rubber, leather, cloth, plastic, or a combination thereof. Additionally or alternatively, the band 74 may be a solid core spool (e.g., a solid core spool from which unused or new fishing line has been removed). The band 74 may have a band width, BW, less than or equal to IRPL.

Referring to FIGS. 3A and 3B, with further reference to FIGS. 1A and 1B, the fishing line spool 6 includes a face plate 20 (e.g., a second face plate), a second spindle securing mechanism 84, and one or more bushings 60. The cross-section of FIG. 3A is taken at line 99 of the end view in FIG. 3B. The shape and configuration of the fishing line spool 6 and the shapes, configurations, and quantities of components thereof, as shown in FIGS. 3A and 3B, are only examples and not limiting of the invention as other shapes, configurations, and quantities in accordance with the disclosure are possible. The fishing line spool 6 may be altered, e.g., by having components added, removed, reshaped, or rearranged.

The structure of the second face plate 20 may be substantially the same as the first face plate 10, with an interior surface 22, an exterior surface 24, a circumferential edge 28, a central bore 26, and slots 31. The second face plate 20 is parallel to the first face plate 10 and separated from the first face plate 10 by a distance, D, between the first face plate 10 and the second face plate 20. The interior surface 22 of the second face plate 20 faces the interior surface 12 of the first face plate 10. The central spindle 40 spans D and the second end portion 46 inserts through the central bore 26. The second end portion 46 of the central spindle 40 may be hollow with a threaded interior surface 48. The central bore 26 may include threads on an interior surface of the central bore 26.

In an embodiment, the second face plate 20 may include a cylindrical tube (not shown) centered on the central bore 26 and extending from the exterior surface 24. An inner diameter of the cylindrical tube may be greater than the diameter of the central spindle 40. The central spindle 40 may insert through the central bore 26 and through the cylindrical tube. The cylindrical tube may maintain a position of the central spindle 40 within the central bore 26.

A spindle securing mechanism 84 (e.g., the second spindle securing mechanism) secures the central spindle 40 to the second face plate 20. The second spindle securing mechanism 84 is centered on the normal central axis 97 and may be disposed on the exterior surface 24 and/or the interior surface 22 of the second face plate 20. For example, the second spindle securing mechanism 84 can include a collar and set screw assembly, a compression fit rubber washer, a nut and washer assembly, etc. As further examples, the exterior surface of the central spindle 40 may be threaded to mate with threads of the central bore 26 to secure the central spindle 40 to the second face plate 20 or the central spindle 40 may be welded, glued, or otherwise bonded to the second face plate 20. The second face plate 20 and the central spindle 40 may be fabricated, for example, machined or molded, as a singular component.

Similarly to the slots 30 of the first face plate 10, the slots 31 extend through the second face plate 20 from the exterior surface 24 to the interior surface 22. The slots 31 are disposed in an area between the central bore 26 and the circumferential edge 28 at a radial distance, R, from the normal central axis 97 and at a regular angular interval, θ, around the central bore 26. SW, SL, and the slot shape of the slots 31 may be substantially the same as the slots 30. Four slots 31 are shown in FIG. 3B as an example only and not limiting of the invention. For example, the second face plate 20 may include two or more slots 31. The number of slots 31 in the second face plate 20 may equal the number of slots 30 in the first face plate 10. The rods 50 span D such that each of the rods 50 inserts into a corresponding slot 31 of the second face plate 20. Further, each of the rods 50 is disposed in the corresponding slot 31 at the slot end portion closest to the circumferential edge 28 of the second face plate 20. The rods 50 may include the end caps 56.

The bushing 60 is a close-fitting, removable sleeve that can surround the supported portion of the central spindle 40. For example, the bushing 60 may be composed, for example, of Teflon®, rubber, plastic, leather, metal, combinations thereof, etc. The bushing 60 may include bearings.

Referring to FIGS. 4A, 4B, 4C, 4D, and 4E, with further reference to FIGS. 1-3B and FIG. 5, schematic diagrams of a top view, an unassembled end view, an assembled end view, and side views of a fishing line spooling apparatus 100 are shown. The shape and configuration of the fishing line spooling apparatus 100 and the shapes, configurations, and quantities of components thereof, as shown in FIGS. 4A, 4B, 4C, 4D, and 4E, are only examples and not limiting of the invention as other shapes, configurations, and quantities in accordance with the disclosure are possible. The fishing line spooling apparatus 100 may be altered, e.g., by having components added, removed, reshaped, or rearranged. At least any or all components of the fishing line spooling apparatus 100 may be substantially composed of wood, one or more metal alloys, one or more corrosion resistant metal alloys, a rigid thermoplastic polymer, or combinations thereof.

Referring to FIG. 4A, a top view of an example of a fishing line spooling apparatus 100 includes a horizontal base plate 110, a first spindle support plate 120, second spindle support plate 130, fishing rod clamp tracks 195, one or more fishing rod clamps 196, and the fishing line spool 6. The horizontal base plate 110 may be a solid or hollow slab. Referring to FIG. 5, the cross-section of the horizontal base plate 110 may have various profiles, for example, 115-a, 115-b, 115-c, 115-d, or 115-e. These profiles are examples only and not limiting of the invention. The horizontal base plate 110 may have a base length, BL, a base width, BW, a first edge 112, and a second edge 114 opposite the first edge 112 across the base width. The first spindle support plate 120 and the second spindle support plate 130 support the central spindle 40. At least one supported portion of the central spindle 40 may include the bushing 60. The bushing 60 may reduce friction between the central spindle 40 and the first spindle support plate 120 and the second spindle support plate 130 during rotation of the central spindle 40 about the normal central axis 97. The rods 50 of the mounted fishing line spool 6 are positioned along the width of the horizontal base plate 110. The first face plate 10 and the second face plate 20 of the mounted fishing line spool 6 are positioned along the length of the horizontal base plate 110. The fishing line spool 6 may include one or more spring and washer assemblies disposed on the central spindle 40. Each spring and washer assembly may include two washers with a spring positioned in between the two washers. The spring and washer assembly may be between the first face plate 10 and the bushing 60 and/or between the second face plate 20 and the bushing 60.

Referring to the unassembled and assembled end views shown in FIGS. 4B and 4C, respectively, the first spindle support plate 120 is secured to a first edge 112 of the horizontal base plate 110 at a bottom portion 126 of the first spindle support plate 120. Similarly, the second spindle support plate 130 is secured to a second edge 114 of the horizontal base plate 110 at a bottom portion 136 of the second spindle support plate 130. The first spindle support plate 120 and the second spindle support plate 130 extend up from the horizontal base plate 110. The first spindle support plate 120 and the second spindle support plate 130 may be secured to the horizontal base plate 110 by, for example, a weld, glue, or other bond, and/or one or more screws, nails, or other securing mechanisms. The first spindle support plate 120 may be parallel to the second spindle support plate 130 and may be perpendicular to the horizontal base plate 110. The interior surface 122 of the first spindle support plate 120 may face the interior surface 132 of the second spindle support plate 130.

The one or more fishing rod clamps 196 are secured to the horizontal base plate 110. The fishing rod clamps 196 are configured to secure a fishing rod 76 including a fishing reel 78 to the horizontal base plate 110. The fishing reel 78 and/or the fishing line spool 6 may include fishing line 77 (e.g., previously used fishing line). For example, the fishing rod clamps 196 may be secured to fishing rod clamp tracks 195 in the horizontal base plate 110. The fishing rod clamp tracks 195 may be slot openings in the horizontal base plate 110 configured to adjustably secure one or more of the fishing rod clamps 196 to the horizontal base plate 110. For example, screws inserted in the bottom 116 of the horizontal base plate 110 may extend up through the fishing rod clamp tracks 195 and insert into threaded holes in the fishing rod clamps 196. The fishing rod clamp tracks 195 enable continuous adjustment of fishing rod clamp positions along the horizontal base plate 110 in order to accommodate various fishing rod lengths, reel seat sizes, and/or reel seat configurations. For example, each fishing rod clamp 196 may include two blocks, each block including a semi-cylindrical cavity on one face of the block. The blocks may be screwed or otherwise secured to the horizontal base plate 110 such that the semi-cylindrical cavities face one another to form a cylindrical cavity along the length, BL, of the horizontal base plate 110. The cylindrical cavity formed by the fishing rod clamps 196 is configured to secure the fishing rod 76. The fishing line spooling apparatus 100 may include fishing rod clamps 196 of various sizes to accommodate a variety of fishing rod diameters. As a further example, the fishing rod clamps 196 may be straps or brackets securable to the horizontal base plate 110 and configured to secure the fishing rod 76. Additionally or alternatively, the fishing line spooling apparatus 100 may include a fishing reel bracket (not shown) configured to secure a fishing reel 78 that is detached from the fishing rod 76. For example, the fishing reel bracket may be secured to the horizontal base plate 110 at a position of one of the fishing rod clamps 196.

Referring to the side view in FIG. 4D, the first spindle support plate 120 includes a U-shaped cut-out 140 that extends from a top edge 128 of the first spindle support plate 120 into a top portion of the first spindle support plate 120. Further, the U-shaped cut-out 140 extends through the first spindle support plate 120 from an exterior surface 124 of the first spindle support plate 120 to an interior surface 122 of the first spindle support plate 120. The second spindle support plate 130 is substantially the same as the first spindle support plate 120.

Referring to the side view in FIG. 4E, similarly to the first spindle support plate 120, the second spindle support plate 130 includes a U-shaped cut-out 142. The U-shaped cut-out 142 extends from a top edge 138 of the second spindle support plate 130 into a top portion of the second spindle support plate 130. Further, the U-shaped cut-out 142 extends through the second spindle support plate 130 from an exterior surface 134 of the second spindle support plate 130 to an interior surface 132 of the second spindle support plate 130.

In an embodiment, the first spindle support plate 120 and the second spindle support plate 130 may each include a support plate bore extending from the exterior surface 124, 134 to the interior surface 122, 132 of the respective spindle support plate. The support plate bore may be circular with a diameter configured to accommodate insertion of the central spindle 40.

The central spindle 40 of the fishing line spool 6 inserts into the first U-shaped cut-out 140 and the second U-shaped cut-out 142 to mount the fishing line spool 6 in the fishing line spooling apparatus 100. The first spindle support plate 120 and the second spindle support plate 130 support the central spindle 40 at portions of the central spindle 40 longitudinally within the first U-shaped cut-out 140 and the second U-shaped cut-out 142.

Referring to FIGS. 6A and 6B, with further reference to FIGS. 1-5, schematic diagrams of a top view and a side view, respectively, of the fishing line spooling apparatus 600 are shown. The shape and configuration of the fishing line spooling apparatus 600 as shown in FIGS. 6A and 6B, and the shapes, configurations, and quantities of components thereof, as shown in FIGS. 6A and 6B, are only examples and not limiting of the invention as other shapes, configurations, and quantities in accordance with the disclosure are possible. The fishing line spooling apparatus 600 may be altered, e.g., by having components added, removed, reshaped, or rearranged. The fishing line spooling apparatus 600 may include a collar 160, a spring-loaded screw 164, spindle clamps 180, a spool handle 170, a drag washer assembly 172, a line counting mechanism 174, a drag scale 176, base clamps 190, clamp openings 192, and suction cups 194.

The collar 160 is disposed on the exterior surface 124 of the first spindle support plate 120 and includes a collar set screw 162 that extends radially through the collar 160. The collar 160 encircles the first end portion 44 of the central spindle 40. The collar set screw 162 is configured to contact the central spindle 40 and to limit lateral motion of the central spindle 40 (e.g., motion in a direction along the width, BW, of the horizontal base plate 110). The spring-loaded screw 164 is disposed in the second end portion 46 of the central spindle 40. The spring-loaded screw 164 is configured to adjustably limit lateral motion of the central spindle 40.

The spindle clamps 180 (e.g., a first spindle clamp and a second spindle clamp substantially identical to the first spindle clamp) are secured to one or both of the top edge 128 of the first spindle support plate 120 and/or the top edge 138 of the second spindle support plate 130. Further, the spindle clamps 180 extend across the U-shaped cut-outs 140, 142 along the top edges 128, 138. The spindle clamps 180 may be, for example, strips composed of metal or plastic and each spindle clamp 180 can include a threaded hole. Spindle clamp screws 182 (e.g., a first spindle clamp screw and a second spindle clamp screw) inserted into the threaded holes in the spindle clamps 180 are configured to contact the central spindle 40 at the supported portions of the central spindle 40 to rotatably secure the central spindle 40 in the fishing line spooling apparatus 600. The spindle clamp screws 182 may be rotated to increase or decrease a pressure on the central spindle 40. The bushings 60, as discussed above, may prevent scoring of the central spindle 40, by the spindle clamp screws 182, during rotation of the central spindle 40. Further, the bushings 60 may enhance an adjustability of a resistance to rotation of the central spindle 40 due to the pressure on the central spindle 40 from the spindle clamp screws 182. Adjustment of the resistance to rotation of the central spindle 40 (i.e., adjustment of the spindle clamp screws 182) can adjust the tension (i.e., the drag) on the fishing line 77.

The spool handle 170 (e.g., a lever, a knob, a T-bar, etc.) is secured to the first end portion 44 of the central spindle 40. The spool handle 170 may enable application of a torque to the central spindle 40 to rotate the fishing line spool 6. The spool handle 170 may include a handle set screw (not shown) and/or a threaded opening to secure the central spindle 40 to the spool handle 170. The spool handle 170 may further include a drag washer assembly 172 and a knob (not shown) configured to adjust the pressure on the drag washer assembly 172. The drag washer assembly 172 is configured to adjust and control the drag on the fishing line 77 wound around the fishing reel 78 as measured by the drag scale 176. In various embodiments, a device secured to the central spindle 40 (e.g., a motor (not shown), a fishing reel handle (not shown), the drill 70) may enable the application of the torque to the central spindle 40. For example, the motor secured to the central spindle 40 may be activated and/or controlled via a wired or wireless connection to a controller and/or a switch (e.g., a hand-held controller, a foot pedal, a joy-stick, a touch pad, a toggle switch, a servo controller, a stepper controller, etc.). The controller and/or the switch may include a remote control device.

The line counting mechanism 174 may be secured to one of the fishing rod clamps 196 or to the horizontal base plate 110. In an embodiment, the line counting mechanism 174 may be secured to the fishing rod clamp tracks 195. The line counting mechanism 174 is configured to measure the length of fishing line 77 wound around the fishing line spool 6 and/or the fishing reel 78. The drag scale 176 may be removably secured to the horizontal base plate 110. The drag scale 176 is configured to measure the drag on the fishing line 77 wound around the fishing reel 78.

The base clamps 190 (e.g., a C clamp, an adjustable clamp, etc.) are configured to insert in clamp openings 192 in order to clamp the fishing line spooling apparatus 100 to a table, boat rail, bench or other surface. One or more suction cups 194 secured to a bottom surface 116 of the fishing line spooling apparatus 100 are configured to secure the fishing line spooling apparatus 100 to a table, boat rail, bench or other surface. The suction cups 194 may include one or more suction locking devices to prevent the loss of suction from the one or more suction cups 194 during operation of the fishing line spooling apparatus 100. In an embodiment, the horizontal base plate 110 may include a leveling apparatus (e.g., a rod holder mount) (not shown) secured to the bottom 116 of the horizontal base plate 110. The leveling apparatus is configured to secure the fishing line spooling apparatus 100 to a fishing rod holder on a boat. The leveling apparatus can enable leveling and positioning adjustment of the fishing line spooling apparatus 100.

Referring to FIGS. 7A, 7B, and 7C, with further reference to FIGS. 1-6, schematic diagrams of a first hinged spindle support plate 720 and a second hinged spindle support plate 730 and of a hinged horizontal base plate 710 with storage compartments 797, 798 are shown. These features provide the advantage of improved portability of the fishing line spooling apparatus 100, 600. The shapes, configurations, and quantities of the components shown in FIGS. 7A, 7B, and 7C, are only examples and not limiting of the invention as other shapes, configurations, and quantities in accordance with the disclosure are possible.

Referring to FIG. 7A, a first hinge 750 may secure the first hinged spindle support plate 720 to the horizontal base plate 110 and/or a second hinge 751 may secure the second hinged spindle support plate 730 to the horizontal base plate 110. The first hinge 750 and the second hinge 751 may be configured such that in a closed position of each of the first hinge 750 and the second hinge 751, the first hinged spindle support plate 720 and the second hinged spindle support plate 730 overlap the horizontal base plate 110. Lowering the first hinged spindle support plate 720 and the second hinged spindle support plate 730 to overlap the horizontal base plate 110 (e.g., as shown schematically in FIGS. 7B and 7C) may improve the portability of the fishing line spooling apparatus 100, 600.

Referring to FIG. 7B, the hinged horizontal base plate 710 may include two or more base plate portions 788, 789 connected by an adjustable connection mechanism 753 (e.g., a base hinge, a bendable member secured to each portion, a connecting latch, a tongue-in-groove assembly etc.) may connect the base plate portions 788, 789. The adjustable connection mechanism 753 may enable the base plate portions 788, 789 to separate or move relative to one another. For example, the adjustable connection mechanism 753 may be configured such that, in an open position of the adjustable connection mechanism 753, the base plate portions 788, 789 are coplanar. Further, in a closed position of the adjustable connection mechanism 753, the base plate portions 788, 789 face one another. As shown schematically in FIG. 7C, in the closed position of the adjustable connection mechanism 753, the components secured to the hinged horizontal base plate 710 (e.g., the first hinged spindle support plate 720, the second hinged spindle support plate 730, the fishing rod clamps 196, and the fishing rod 76) may be in between the base plate portions 788, 789. The hinged horizontal base plate 710 may further include adjustable stabilizer latches (not shown) configured to prevent relative motion of the base plate portions 788, 789.

The horizontal base plate 110 and/or the hinged horizontal base plate 710 may further include one or more storage compartments 797, 798. The storage compartments 797, 798 may be constitutive of the horizontal base plate 110, 710 or may be discrete components (i.e., non-constitutive) secured to the horizontal base plate 110, 710. The storage compartments 797, 798 may include a fishing line spool compartment 797 for the fishing line spool 5, 6. The fishing line spool compartment 797 may conform to the shape of the fishing line spool 5, 6. The shape of the fishing line spool compartment 797 and/or the horizontal base plate material may enable the fishing line spool 5, 6 to be pushed in and out of the fishing line spool compartment 797. The storage compartments 797, 798 may further include an equipment storage compartment 798. The equipment storage compartment 798 may be configured to store lures, the fishing line 77, the fishing reel 78, tools, supplies, etc.

Referring to FIG. 8, with further reference to FIGS. 1-7, a method 800 of removing fishing line from a fishing reel includes the stages shown. The method 800 is, however, an example only and not limiting. The method 800 can be altered, e.g., by having stages added, removed, rearranged, combined, performed concurrently, and/or having single stages split into multiple stages.

At stage 805, the method 800 includes mounting a first fishing line spool. The first fishing line spool 5, 6 is mounted in a rotation apparatus (e.g., the fishing line spooling apparatus 100, 600 or the drill 70). For example, the fishing line spool 6 (e.g., a first fishing line spool 6) including the second face plate 20 and/or the end caps 56 is mounted in the fishing line spooling apparatus 100, 600. One or more spindle clamp screws 182 are rotated such that the spindle clamp screws 182 contact the central spindle 40. Alternatively, the first fishing line spool 5 is mounted in the chuck 72 of the drill 70.

At stage 825, the method 800 includes securing an end of a length of fishing line spooled on a fishing reel to the mounted first fishing line spool. The length of fishing line 77 may be previously used fishing line. For example, the end of the length of fishing line 77 is tied to at least one rod 50 of the mounted first fishing line spool 5, 6. The fishing reel 78 may be secured to the fishing rod 76 clamped in the fishing rod clamps 196 or may be secured in the fishing reel bracket as discussed above with regard to FIGS. 6A and 6B.

At stage 835, the method 800 includes rotating the mounted first fishing line spool. For example, a torque is applied (e.g., manually or by a motor, a fishing reel handle, the spool handle 170, the drill 70, etc.) to the central spindle 40 and the mounted first fishing line spool 5, 6 is rotated around the normal central axis 97. In an example, the drill 70 may apply the torque to the central spindle 40 mounted in the fishing line spooling apparatus 100. Based on the rotation direction of the mounted first fishing line spool 5, 6, the fishing line 77 is unwound from the fishing reel 78 and wound around the rods 50 of the mounted first fishing line spool 5, 6.

At stage 855, the method 800 includes determining reuse of the fishing line. For example, if the fishing line 77 is reused, the method 800 proceeds to stage 865 or stage 884. If the fishing line 77 is discarded, the method 800 proceeds to stage 872. At stage 855, the method 800 optionally includes unmounting the first fishing line spool 5, 6. For example, the first fishing line spool 5, 6, including fishing line 77 wound around the rods 50, is unmounted from the rotation apparatus (e.g., fishing line spooling apparatus 100 or the drill 70). For example, the one or more spindle clamp screws 182 are rotated such that the spindle clamp screws 182 are extracted from the spindle clamps 180. The spindle clamps 180 are removed from the first spindle support plate 120 and/or the second spindle support plate 130. The collar set screw 162 of the collar 160 and the spring-loaded screw 164 are rotated to release the central spindle 40 and the central spindle 40 is slid and/or lifted out of the U-shaped cut-outs 140, 142. As a further example, the first fishing line spool 5 is unmounted from the drill 70. For example, the chuck 72 of the drill 70 is rotated to release the central spindle 40 from the chuck 72. At stage 855, the method 800 further optionally includes detaching the second face plate 20 and/or the end caps 56. For example, the second spindle securing mechanism 84 is adjusted and/or removed to release the central spindle 40 from the second face plate 20 of the first fishing line spool 6 and/or the end caps 56 are removed from the rods 50. The second face plate 20 is slid along the rods 50 in a direction away from the first face plate 10 to remove the second face plate 20.

At stage 865, the method 800 includes storing the first fishing line spool. The first fishing line spool 5, 6 and the fishing line 77 wound on the first fishing line spool 5, 6 may be stored during maintenance and cleaning of a fishing rod and reel, between fishing seasons, or during use of a different fishing line on a particular fishing rod and reel. A user may remove, for example, a small portion of the fishing line damaged due to repetitive line tension and exposure to ultra-violet radiation outdoors. The remainder of the fishing line in satisfactory condition for reuse may be stored on the first fishing line spool 5 and may be rewound onto a fishing reel 78. This provides, for example, at least the advantage of reducing costs associated with fishing by reusing the stored used fishing line rather than purchasing new fishing line.

At stage 884, the method 800 includes inserting the rods of a second fishing line spool within a diameter of fishing line 77 wound around the rods of the first fishing line spool. For example, the rods 50 of the second fishing line spool 5, 6 are inserted within the diameter of fishing line 77 wound around the first fishing line spool 5, 6. The structure of the second fishing line spool 5, 6 may be substantially the same as the first fishing line spool 5, 6. During insertion, the second fishing line spool 5, 6 may not include end caps 56 or a second face plate 20. The first fishing line spool 5, 6 may include the band 74 and the inner diameter of the fishing line 77 may be defined by the band 74.

At stage 885, the method 800 includes adjusting at least one rod securing mechanism. For example, at least one rod securing mechanism 82 is rotated in a direction away from the first face plate 10. Such a rotation enables the corresponding rod 50 to slide within the corresponding slot 30.

At stage 886, the method 800 includes sliding at least one rod of the first fishing line spool along the corresponding slot. For example, at least one rod securing mechanism 82 is adjusted so that the at least one rod 50 can slide along the corresponding slot 30 towards the center of the first face plate 10. Sliding the rod 50 reduces tension on the wound fishing line 77 and the reduced tension enables removal of the fishing line 77 from the first fishing line spool 5.

At stage 887, the method 800 includes transferring the fishing line from the first fishing line spool to the second fishing line spool. For example, with the tension on the wound fishing line 77 reduced by the sliding of the at least one rod 50 towards the center of the first face plate 10, the wound fishing line 77 is supported by the rods 50 of the second fishing line spool 5, 6. The first fishing line spool 5, 6 is moved in a direction away from the second fishing line spool 5, 6 and the fishing line 77 is transferred to the second fishing line spool 5, 6. The second fishing line spool 5, 6 including the used fishing line 77 may be stored and/or mounted in the fishing line spooling apparatus 100, 600 or the drill 70. The first fishing line spool may be reused as described below at stage 879.

At stage 872, the method 800 includes adjusting at least one rod securing mechanism. For example, at least one rod securing mechanism 82 is rotated in a direction away from the first face plate 10. Such a rotation enables the corresponding rod 50 to slide within the corresponding slot 30.

At stage 874, the method 800 includes sliding at least one rod of the first fishing line spool along the corresponding slot. For example, as described above with regard to stage 886, the at least one rod securing mechanism 82 is adjusted so that the at least one rod 50 can slide along the slot 30 towards the center of the first face plate 10 to reduce the tension on the fishing line 77 wound around the first fishing line spool 5, 6. If the first fishing line spool includes the second face plate 20, the at least one rod 50 also slides along the corresponding slot 31 towards the center of the second face plate 20. Optionally, at stage 874, the method 800 includes detaching the first face plate 10 or the second face plate 20. Removing the rod securing mechanism 82 from each rod 50 and releasing the first spindle securing mechanism 80 enables removal of the first face plate 10 from the fishing line spool 5, 6. Releasing the second spindle securing mechanism 84 and removing the end caps 56 enables removal of the second face plate 20.

At stage 876, the method 800 includes removing the fishing line from the first fishing line spool. For example, the fishing line is moved in a direction away from the first face plate 10 to remove the fishing line 77 from the first fishing line spool 5, 6. The removed fishing line 77 may be discarded.

At stage 878, the method 800 includes securing the at least one rod to the first fishing line spool. For example, the at least one rod 50 is slid along the corresponding slot 30 in a direction towards the circumferential edge 18 of the first face plate 10. The at least one rod securing mechanism 82 is rotated to secure the at least one rod 50, for example, at the slot end portion closest to the circumferential edge 18.

At stage 879, the method 800 includes reusing the first fishing line spool. For example, the fishing line spool 5, 6 is remounted in the fishing line spooling apparatus 100 or the drill 70. Fishing line 77 (e.g., previously used fishing line removed from a fishing reel 78) is wound around the rods 50 of the first fishing line spool 5, 6. This provides, for example, at least the advantage of reducing costs associated with fishing by reusing the first fishing line spool 5, 6.

Referring to FIG. 9, with further reference to FIGS. 1-8, a method 900 of relining a fishing reel includes the stages shown. The method 900 is, however, an example only and not limiting. The method 900 can be altered, e.g., by having stages added, removed, rearranged, combined, performed concurrently, and/or having single stages split into multiple stages.

At stage 910, the method 900 includes mounting a fishing line spool in a fishing line spooling apparatus. For example, the fishing line spool 6 includes a length of fishing line 77 wound around the rods 50 and is mounted in the fishing line spooling apparatus 100, 600. One or more spindle clamp screws 182 are rotated to contact the central spindle 40 in order to maintain the central spindle 40 in the U-shaped cut-outs 140,142. The fishing line spool 6 can include a length of previously used fishing line 77 (e.g., previously used fishing line 77 stored at stage 865 of the method 800 and/or previously used fishing line 77 transferred at stage 887 of the method 800).

At stage 920, the method 900 includes securing an end of a length of fishing line wound on the fishing line spool to a fishing reel. For example, the end of the length of used fishing line 77 wound on the fishing line spool 6 is tied to the fishing reel 78. The fishing reel 78 is secured to the fishing reel bracket secured to the horizontal base plate 110, 710 or to the fishing rod 76 clamped in the fishing rod clamps 196.

At stage 930, the method 900 includes rotating the fishing line spool. For example, a torque is applied (e.g., manually or by a motor, a fishing reel handle, the spool handle 170, the drill 70, etc.) to the central spindle 40 and the fishing line spool 6 is rotated around the normal central axis 97. By rotating the fishing line spool 6, the used fishing line 77 is unwound from the fishing line spool 6.

At stage 940, the method 900 includes winding the fishing line around the fishing reel. For example, the used fishing line 77 from the fishing line spool 6 is wound around the fishing reel 78 (e.g., to reline the fishing reel 78) by moving a fishing reel handle. The drag on the fishing line 77 is adjusted via the drag washer assembly 172 and/or the spindle clamp screws 182. The drag on the fishing line 77 is measured by the drag scale 176 and the line length is measured by the line counting mechanism 174.

At stage 950, the method 900 includes unmounting the fishing line spool from the fishing line spooling apparatus. For example, unmounting the fishing line spool 6 from the fishing line spooling apparatus 100, 600 is enabled by rotating the spindle clamp screws 182 so that the spindle clamp screws 182 are not in contact with the central spindle 40 and removing the spindle clamps 180.

Other Considerations

As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

As used herein, including in the claims, unless otherwise stated, a statement that a function or operation is “based on” an item or condition means that the function or operation is based on the stated item or condition and may be based on one or more items and/or conditions in addition to the stated item or condition.

Other examples and implementations are within the scope and spirit of the disclosure and appended claims. Further, more than one invention may be disclosed.

The items and methods discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known structures, processes, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

What is claimed is:

1. A method of removing previously used fishing line from a fishing reel, the method comprising:
mounting a fishing line spool in a rotation apparatus wherein the fishing line spool comprises four rods and a face plate including four elliptical slots, each rod slidably secured via a rod securing mechanism to a corresponding elliptical slot at a slot end portion closest to a circumferential edge of the face plate;
rotating the mounted fishing line spool wherein the rotating removes the previously used fishing line from the fishing reel and winds the previously used fishing line around the four rods;
adjusting at least one rod securing mechanism;
sliding at least one rod along the corresponding elliptical slot towards a center of the face plate wherein the sliding reduces tension on the previously used fishing line;
removing the previously used fishing line from the fishing line spool;
securing the at least one rod to the corresponding elliptical slot at the slot end portion closest to the circumferential edge of the face plate;
reusing the fishing line spool.

2. A fishing line spool comprising:
a first face plate, substantially in a disc shape, with an interior surface, an exterior surface, and a circumferential edge, the first face plate comprising:
a central bore in the first face plate, the central bore being disposed in an approximate center of the first face plate and extending through the first face plate from the exterior surface to the interior surface; and
a plurality of slots extending through the first face plate from the exterior surface to the interior surface and in an area between the central bore and the circumferential edge of the first face plate, wherein each of the plurality of slots is disposed at a regular angular interval around the central bore and at a radial distance from the central bore;
a central spindle secured to the first face plate and extending from the central bore; and
a plurality of rods, wherein each rod of the plurality of rods extends from a corresponding slot of the plurality of slots and wherein a first end portion of each rod is slidably secured to the corresponding slot.

3. The fishing line spool of claim 2 wherein each slot has a slot length along a radial direction wherein the slot length is greater than a slot width along an angular direction.

4. The fishing line spool of claim 2 wherein each of the plurality of rods is slidably secured to a slot end portion closest to the circumferential edge of the first face plate.

5. The fishing line spool of claim 2 wherein a second end portion of each rod includes an end cap, an outer diameter of the end cap being greater than a rod diameter of a corresponding rod.

6. The fishing line spool of claim 2 wherein the first face plate, the plurality of rods, and the central spindle are substantially composed of one or more corrosion resistant materials.

7. The fishing line spool of claim 2 wherein at least a first end portion of the central spindle has a cross-sectional shape compatible with a chuck of a drill.

8. The fishing line spool of claim 2, further comprising a second face plate substantially the same as the first face plate, the second face plate being parallel to the first face plate and separated from the first face plate by a distance between the first face plate and the second face plate, wherein an interior surface of the second face plate faces the interior surface of the first face plate,
wherein the central spindle spans the distance between the first face plate and the second face plate and inserts through a central bore in the second face plate and is secured to the second face plate, and
further wherein the plurality of rods span the distance between the first face plate and the second face plate and each of the plurality of rods inserts into one of a plurality of slots in the second face plate.

9. The fishing line spool of claim 8 wherein the central spindle is rotatably secured to a fishing line spooling apparatus.

10. A fishing line spooling apparatus comprising:
a horizontal base plate with a first edge and a second edge opposite the first edge;
a first spindle support plate extending up from the horizontal base plate and including a U-shaped cut-out extending from a top edge of the first spindle support plate into a top portion of the first spindle support plate, the first spindle support plate being secured to the first edge of the horizontal base plate at a bottom portion of the first spindle support plate;
a second spindle support plate substantially the same as the first spindle support plate, the second spindle support plate being secured to the second edge of the horizontal base plate along a bottom portion of the second spindle support plate;
one or more fishing rod clamps secured to the horizontal base plate; and
a fishing line spool including a plurality of slidable rods and a central spindle wherein the central spindle is disposed in the U-shaped cut-out of the first spindle support plate and the U-shaped cut-out of the second spindle support plate.

11. The fishing line spooling apparatus of claim 10 wherein the fishing line spool includes a length of previously used fishing line.

12. The fishing line spooling apparatus of claim 10 further comprising:
a collar, disposed on an exterior surface of the first spindle support plate, that encircles a first end portion of the central spindle and a set screw that extends into the collar and is configured to contact the first end portion; and
a spring-loaded screw that inserts into a second end portion of the central spindle wherein the second end portion of the central spindle is hollow and an interior surface of the second end portion is threaded.

13. The fishing line spooling apparatus of claim 10 wherein at least one supported portion of the central spindle includes a bushing.

14. The fishing line spooling apparatus of claim 10 further comprising at least one of:
a first spindle clamp secured to the top edge of the first spindle support plate wherein the first spindle clamp extends across the U-shaped cut-out in the first spindle support plate along the top edge of the first spindle support plate and further wherein a first spindle clamp screw extends into the U-shaped cut-out in the first spindle support plate and is configured to contact the central spindle; or
a second spindle clamp secured to the top edge of the second spindle support plate wherein the second spindle clamp extends across the U-shaped cut-out in the second spindle support plate along the top edge of the first spindle support plate and further wherein a second spindle clamp screw extends into the U-shaped cut-out in the second spindle support plate and is configured to contact the central spindle.

15. The fishing line spooling apparatus of claim 10 wherein the first spindle support plate is secured to the horizontal base plate via a first hinge and the second spindle support plate is secured to the horizontal base plate via a second hinge such that, in a closed position of the first hinge and the second hinge, the first spindle support plate and the second spindle support plate overlap the horizontal base plate.

16. The fishing line spooling apparatus of claim 10 wherein the horizontal base plate includes one or more fishing rod clamps secured to fishing rod clamp tracks wherein the fishing rod clamp tracks are configured to enable adjustment of a position of the one or more fishing rod clamps.

17. The fishing line spooling apparatus of claim 10 further comprising a spool handle secured to a first end portion of the central spindle wherein the spool handle includes a drag washer assembly.

18. The fishing line spooling apparatus of claim 10 further comprising a line counting mechanism.

19. The fishing line spooling apparatus of claim 10 further comprising a drag scale removably secured to the horizontal base plate.

20. The fishing line spooling apparatus of claim 10 wherein the horizontal base plate comprises at least two base plate portions connected by an adjustable connection mechanism.
